(19) United States
(12) Patent Application Publication
(10) Pub. No.: US 2008/0264923 A1
(43) Pub. Date: Oct. 30, 2008

(54) WELDING SYSTEM AND METHOD WITH IMPROVED WAVEFORM

(75) Inventor: Galen Jon White, Bartlett, IL (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/108,227

(22) Filed: Apr. 23, 2008

Related U.S. Application Data
(60) Provisional application No. 61/066,138, filed on Apr. 30, 2007.

(51) Int. Cl. B23K 9/00

(52) U.S. Cl. 219/137 PS; 219/136; 323/212

(57) ABSTRACT

Provided is a welding system and method for controlling a welding system with an improved waveform. In accordance with one aspect of the present invention, a welding system waveform is calibrated such that the welding transfer regularly occurs during short circuits, comprising applying a voltage and a current to a welding electrode, applying an increased voltage and an increased current to the welding electrode, increasing the current to the welding electrode when a short circuit is detected, and maintaining the increased current applied to the welding electrode until a desired time expires after the short circuit is detected or until the short circuit clears, whichever occurs first.

### CROSS REFERENCE TO RELATED APPLICATIONS

This application is a Non-Provisional patent application of U.S. Provisional Patent Application No. 61/066,138, entitled “Welding System and Method with Improved Waveform”, filed Apr. 30, 2007, which is herein incorporated by reference.

### BACKGROUND

The invention relates generally to the field of welding systems, and particularly to pulsed gas metal arc welding systems (GMAW-P), also known as pulsed metal inert gas (pulsed MIG) welding systems.

Arc welding systems generally comprise a power supply that applies electrical current to an electrode so as to pass an arc between the electrode and a work piece, thereby heating the electrode and work piece to create a weld. In many systems, such as gas metal arc welding systems (GMAW), the electrode consists of a wire which is advanced through a welding torch. As the electrode is heated by the arc, the electrode melts and is joined to molten metal of the work piece to form the weld. By controlling the supply of voltage and current to the electrode, a GMAW system may control the manner in which the electrode is melted and deposited by the arc. For example, the voltage supply to the electrode may be held constant, while the current supply is varied so as to maintain a constant arc length independent of the distance between the contact tip and the work piece. A GMAW system may also supply voltage and current to an electrode in a periodic or pulsed manner, known as pulsed gas metal arc welding (GMAW-P) or pulsed metal inert gas (pulsed MIG) welding.

In a GMAW system, the arc performs two critical functions. First, the arc melts the end of the electrode into a molten ball. Second, the arc then transfers the molten ball of electrode material onto the work piece and into the weld puddle. Of the two critical functions, transferring the molten ball of electrode material onto the work piece requires significantly higher power. Accordingly, a GMAW system operating at a single constant voltage must operate at a relatively high voltage. Maintaining a high constant voltage adds more heat to the work piece and consumes more power than necessary. The additional heat results in a weld puddle which may be too fluid for some applications, such as overhead or vertical welding. Excessive heat may also cause thinner work pieces to warp and distort.

Rather than provide a single constant voltage- or constant current-controlled arc, GMAW-P welding systems supply voltage and current to the electrode according to a periodic pattern. For example, a GMAW-P welding system may supply a constant low voltage in a first phase (the background phase), and then supply a constant high voltage in a second phase (the peak phase). In such a way, an arc may provide only enough power to melt the electrode in the background phase, while providing sufficient power to transfer the molten electrode material to the weld puddle in the peak phase. A GMAW-P system may allow a variety of parameters to be programmed, such as constant voltage levels, fixed current beginning points, constant current ramp rates, minimum and maximum current limits, time allowed for each phase, and so forth. The increased control offered by GMAW-P may reduce overall current consumption and thus minimize excess heat and work piece distortion, lessen the fluidity of the weld puddle, allow for a smaller weld puddle, and offer greater control over weld penetration.

Though GMAW-P represents an improvement over typical GMAW, some problems persist. Because the arc generally transfers the molten ball of electrode material onto the work piece during a high power peak phase, the transfer often occurs rapidly. The rapid transfer may cause the molten ball of electrode material or the weld puddle to spatter. The high power of the peak phase may also heat the molten ball of electrode material beyond its boiling point, resulting in “outgassing” and microspatter caused by electrode vaporization.

Occasionally, the molten ball does not completely transfer. If part of the molten electrode material remains connected both to the electrode tip and the weld puddle, a short circuit occurs and the arc may be extinguished. Often, a restrike phase is then initiated, during which the current rises rapidly to force the transfer of molten electrode material and thus restrike the arc. While such a restrike phase usually succeeds, at the moment the arc restrikes the current and voltage may be very high. The high energy of the arc may cause the weld puddle to spatter and generate excessive heat. For at least these reasons, GMAW-P systems generally seek to avoid short-circuit conditions. While some software-controlled GMAW-P systems may take implement schemes to predict clearing of short-circuit conditions, such systems may be more expensive or unwieldy than more common GMAW-P systems.

In addition to the foregoing issues with gas shielded welding applications, waveforms similar to those used in MIG welding are sometimes used with metal core welding wires. Such welding wires generally comprise a sheath or shell in which a metal powder core is disposed and compressed. The sheath may be the same as the core, or may be different from the core so as to create a composite metallurgy when the two are melted. The core may also provide materials for shielding the weld pool. Conventional pulsed waveforms have not been widely used in such applications, however, particularly due to the higher levels of heating that may adversely affect the core of the wires.

### BRIEF DESCRIPTION

The invention provides a system and method of welding using an improved waveform to address such needs. In accordance with one aspect of the present invention, a welding system waveform is calibrated such that the welding transfer regularly occurs during short circuits. The width of the high power peak phase of a GMAW-P waveform is minimized, such that a molten ball of electrode material on the tip of a welding electrode only substantially begins to transfer during the peak phase. The voltage level of a background phase is similarly minimized, such that the background voltage is low enough to regularly cause short circuits, but high enough to preheat the end of the wire in preparation for the next pulse.

In accordance with another aspect of the present invention, the welding system waveform does not immediately undertake a restrike phase when a short circuit occurs. Instead, a restrike delay phase is initiated to allow the short circuit to clear on its own. Current is maintained at a constant low level, calculated such that the molten ball remains substantially fluid while preventing excessive spatter when the arc restrikes.

In accordance with yet another aspect of the present invention, the welding system waveform does not immediately return to a background phase when a short circuit clears and the arc restrikes. Instead, a restrike return phase minimizes the impact of the restriking arc. Current is immediately reduced to a very low level when the system detects that the short circuit is about to clear.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary welding system in accordance with one embodiment of the present invention;

FIG. 2 illustrates an exemplary voltage and current waveform in accordance with an embodiment of the present technique;

FIG. 3 illustrates an exemplary voltage and current waveform in which a short circuit does not clear on its own and a restrike phase is employed to clear the short circuit, in accordance with an embodiment of the present technique;

FIG. 4 illustrates an exemplary magnified view of a welding electrode during a first background phase in accordance with an embodiment of the present technique;

FIG. 5 illustrates an exemplary magnified view of a welding electrode during a peak phase in accordance with an embodiment of the present technique;

FIG. 6 illustrates an exemplary magnified view of a welding electrode during a second background phase in accordance with an embodiment of the present technique;

FIG. 7 illustrates an exemplary magnified view of a welding electrode during a restrike delay phase in accordance with an embodiment of the present technique;

FIG. 8 illustrates an exemplary magnified view of a welding electrode immediately following a restrike in accordance with an embodiment of the present technique; and

FIG. 9 is a flowchart illustrating a method of controlling the voltage and current to the welding electrode in accordance with an embodiment of the present technique.

### DETAILED DESCRIPTION

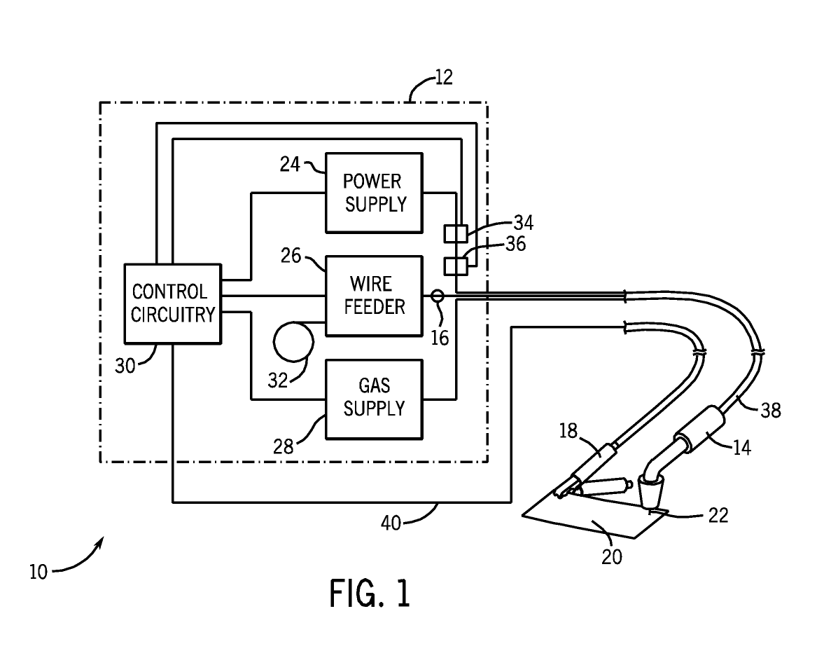

FIG. 1 illustrates an exemplary welding system 10 which is configured to utilize the present technique. Prior to continuing, however, it is worth noting that the following discussion merely relates to exemplary embodiments of the present technique. As such, the appended claims should not be viewed as limited to those embodiments described herein.

The exemplary welding system 10 includes a base unit 12 operably coupled with a welding torch 14. Placement of the welding torch 14 proximate to work piece 20 allows electrical current, supplied by power supply 24, to form an arc 22 from electrode 16 to the work piece 20. The arc 22 completes an electrical circuit from power supply 24 to electrode 16, to the work piece 20, then back to ground via ground clamp 18 and ground cable 40, which is operably coupled to power supply 24 through control circuitry 30. The heat produced by arc 22 causes the electrode 16 and/or work piece 20 to transition to a molten state, facilitating the weld.

Base unit 12 supplies welding torch 14 with voltage and current from power supply 24, electrode 16 from electrode supply 32 via wire feeder 26, and shielding gas from gas supply 28 through conduit 38. The electrode 16 may be of various types, including traditional wire electrode or gasless wire electrode. Shielding gas from gas supply 28 shields the weld area from contaminants during welding, to enhance arc performance, and to improve the resulting weld.

To precisely control the deposition of molten material from electrode 16 onto work piece 20, the control circuitry 30 varies the voltage and current supplied by power supply 24 to welding torch 14 according to a predetermined algorithm, as discussed in greater detail below. Control circuitry 30 monitors the supply voltage and current with voltage sensor 34 and current sensor 36. By varying the voltage and current supplied by power supply 24 to welding torch 14, the control circuitry 30 controls the intensity of the arc 22 and, accordingly, the manner in which the molten material from electrode 16 is deposited onto the work piece 20.

It should be noted that, as described below, pulsed waveforms provided by the present techniques may be applied to welding systems utilizing metal core welding wires as well. As will be appreciated by those skilled in the art, such wires may be used with welding power supplies similar or even identical to those used for solid wire welding applications.

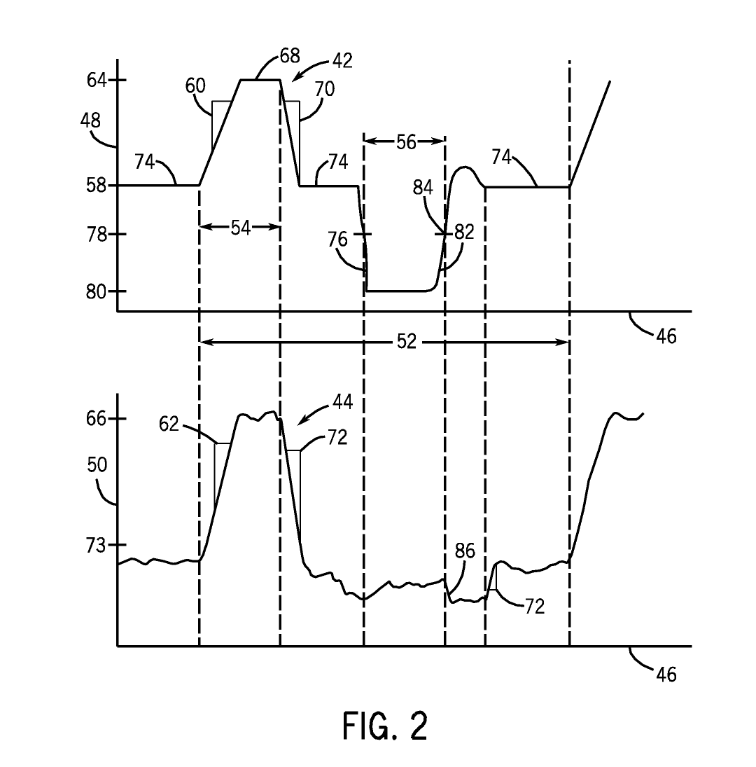

FIG. 2 illustrates an exemplary voltage waveform 42 with voltage axis 48 and current waveform 44 with current axis 50, both across time axis 46, as implemented by control circuitry 30 with power supply 24. Voltage waveform 42 comprises segments of constant voltage, while current waveform 44 comprises segments which allow current to vary during corresponding constant voltage segments and segments which ramp current up or down at constant rates. The waveforms repeat at a predetermined frequency with a period 52.

Referring to voltage waveform 42, first constant voltage segment 74 represents a first background phase, during which background voltage level 58 is held constant. On current waveform 44, the corresponding current during the first background phase is allowed to vary so as to maintain arc 22. In the exemplary voltage waveform 42, background voltage level 58 is low enough such that short circuits will regularly occur during a later phase, as discussed in greater detail below, but high enough to preheat the tip of electrode 16 to form a molten ball of electrode material before the proximate voltage increase. Accordingly, in various embodiments the background voltage level 58 ranges from 17V to 20V, but depending on variables such as frequency, wire feed speed (WFS), peak voltage level 64, choice of electrode 16, etc., the background voltage may be higher or lower.

Immediately following the first constant voltage segment 74, the first background phase ends and a peak phase begins. Current increases at peak current ramp rate 62 to peak current level 66. Once the current reaches peak current level 66, voltage is commanded to reach peak voltage level 64 during segment 68, rising at a rate 60 (not commanded, but resulting from the commanded ramp-up of the current waveform), and then may remain at level 66 until peak phase time 54 expires, ending the peak phase. During segment 68, current is allowed to fluctuate while voltage remains constant until the peak phase time 54 expires.

The peak voltage level 64, peak phase time 54, peak current ramp rate 62, and initial peak current level 66 may be chosen so as to minimize overheating of the molten electrode material while substantially initializing the transfer of molten electrode material toward the weld puddle. Because the power flowing through arc 22 during the peak phase may be much higher than during a background phase, an embodiment of the present technique may employ a relatively short peak phase time 54, constituting between approximately one-tenth to one-third the total waveform period. In an embodiment operating at 220 Hz and with background voltage level 58 at 17 V, a peak voltage level 64 may be 35 V and the peak phase time 54 may be 1.0 ms. For the same embodiment, the peak current ramp rate 62 may be 1000 A/ms and the initial peak current 66 may be 550 A.

Continuing to refer to FIG. 2, the second background phase begins immediately after the peak phase time 54 expires. Amperage decreases at background current ramp rate 72 causing a reduction in voltage, as indicated by reference numeral 70, until the a background current level 73 is reached. To maximize the precision of the voltage and current pulse, background current ramp rate 72 may be significantly faster than peak current ramp rate 62. In one embodiment, background current ramp rate 72 is 2000 A/ms, double the peak current ramp rate 62 of 1000 A/ms. As during the first background phase, the voltage is then maintained at background voltage level 58 while the current varies for the duration of the second background phase.

The molten electrode material may typically reach the weld puddle while still attached to the tip of electrode 16, causing a short circuit and extinguishing the arc 22. The short circuit may be detected at the point that voltage drop 76 crosses threshold voltage 78, triggering the end of the second background phase and the beginning of the restrike delay phase. During the restrike delay phase, current may be temporarily held constant at a restrike delay current level to allow the short circuit to clear on its own. The restrike delay current level may be high enough to keep the molten electrode material substantially fluid while it transfers to the weld puddle, but low enough not to cause excessive spatter when the short circuit clears and the arc 22 restrikes. Accordingly, in one embodiment, the restrike delay current level is 80 A.

The restrike delay phase ends when either the restrike delay phase time 56 expires or when the short circuit clears on its own, whichever occurs first. Note that restrike delay phase time 56 represents a fixed upper bound of time allowed for the short circuit to clear on its own and that the arc restrike 84 will not necessarily occur at the same time the restrike delay phase time 56 expires. If the short circuit does not clear by the time the restrike delay phase time 56 expires, the restrike phase will begin (not shown in FIG. 2), discussed in greater detail below. It should be noted that as the molten electrode material detaches from the tip of electrode 16 and the short circuit begins to clear, a voltage increase 82 naturally occurs; the arc restrike 84 occurs approximately at the point the voltage crosses threshold voltage 78 and the system detects that the short circuit has cleared.

If the short circuit clears before the restrike delay phase time 56 expires, the waveform immediately enters a restrike return phase. At the moment the voltage crosses threshold voltage 78 and enters the restrike return phase, current is rapidly ramped down at restrike return current ramp rate 86 and held constant at the restrike return current level for a desired time to allow voltage to stabilize around background voltage level 58. By reducing the current when arc 22 restrikes and the voltage is rising, the total power of arc 22 is reduced. Undesired effects, such as excessive spatter and microspatter, may thus be minimized. For the same reason, the restrike return current ramp rate 86 should be chosen to very rapidly drop the current, and may reach greater than 1000 A/ms. After the desired time has expired for the restrike return phase, the cycle begins again at a first background phase.

The waveform illustrated in FIG. 2 exhibits a number of novel and advantageous features. For example, during programming, the duration 54 may be set, as may the ramp rate 62. This effectively determines the duration that the voltage will stay at the “peak” level (i.e., the pulse width of the peak current pulse). In a presently contemplated embodiment, for example, the ramp rate 60 may be set to approximately 1000 A/ms, although other rates may be used. During the rise in voltage between the background level 74 and the peak level 68, the system effectively controls current, while during the peak voltage segment 68, voltage is controlled. Subsequently, during the ramp-down of voltage from the peak voltage segment, current is one again controlled.

As discussed in greater detail below, the availability of the very short peak current pulse, and the ability to control the pulse offers the potential for application of the waveforms and control techniques both for pulsed MIG and for metal core wire welding tasks. The reduced input of power or energy enables the welding of thin materials that would otherwise burn through with more conventional pulsed and non-pulsed techniques. In the case of metal core wires, heating is reduced, avoiding potential damage to the wires, and particularly to their cores.

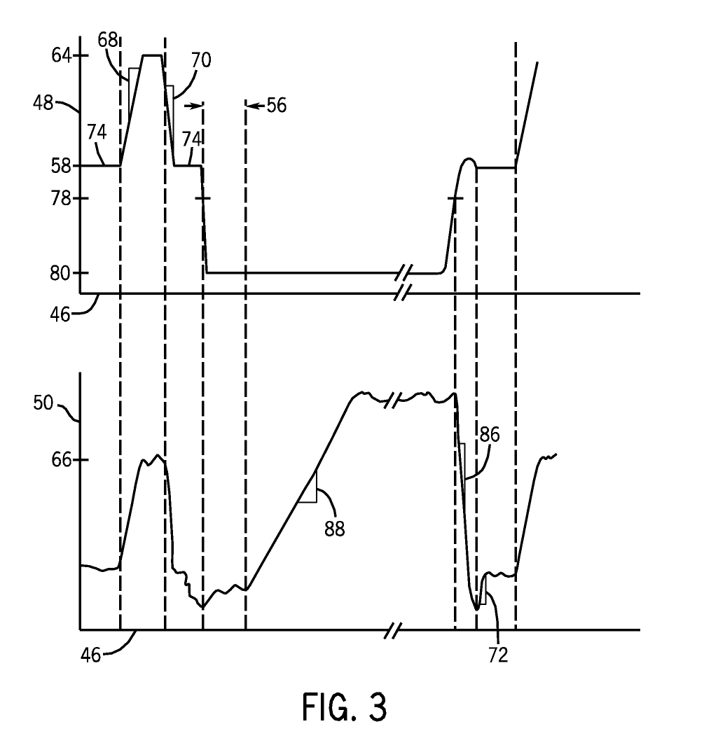

A short circuit will ordinarily clear on its own during the restrike delay phase, but occasionally the short circuit does not clear before the restrike delay phase time 56 expires. Turning now to FIG. 3, the exemplary voltage waveform and current waveform represent alternative waveforms which result if, during a restrike delay phase, a short circuit instead fails to clear on its own before the restrike delay phase time 56 expires. Though the waveforms of FIG. 3 remain substantially identical to the waveforms of FIG. 2 from the first background phase through the restrike delay phase, the waveforms depicted in FIG. 3 comprise a restrike phase after the restrike delay phase. The restrike phase is calculated to force a short circuit to clear when the short circuit fails to clear on its own during the restrike delay phase.

As depicted in FIG. 3, if during the restrike delay phase the voltage does not cross threshold voltage 78 before restrike delay phase time 56 expires to signal the short circuit has cleared, a restrike phase may begin. During the restrike phase current ramps up rapidly at restrike current ramp rate 88 to the restrike current level, where the current is held high for a desired restrike phase time or until the short clears, whichever occurs first. To ensure the arc 22 restrikes during the restrike phase, the restrike current level may reach beyond one hundred amperes higher than the initial peak current level 66, and the restrike phase time may span many times the ordinary period of the waveform. For example, when the initial peak current level 66 is set to 550 A, the restrike current level may be set to 700 A; when the ordinary waveform period 52 (depicted in FIG. 2) is approximately 4.5 ms, the restrike phase time may endure 65.5 ms or longer. Because of the very high current through the molten electrode material during the restrike phase, the short circuit will almost certainly clear before the restrike phase time expires.

Continuing to refer to FIG. 3, once the short circuit clears and is detected when the voltage crosses threshold voltage 78, the waveform may enter a restrike return phase. The restrike return phase operates in substantially the same fashion as depicted in FIG. 2, ramping current down at restrike current ramp rate 86 and holding current constant at the restrike return current level for a desired time to allow voltage to stabilize around background voltage level 58. When the desired restrike return time expires, the waveform returns to a first background phase, restarting the cycle.

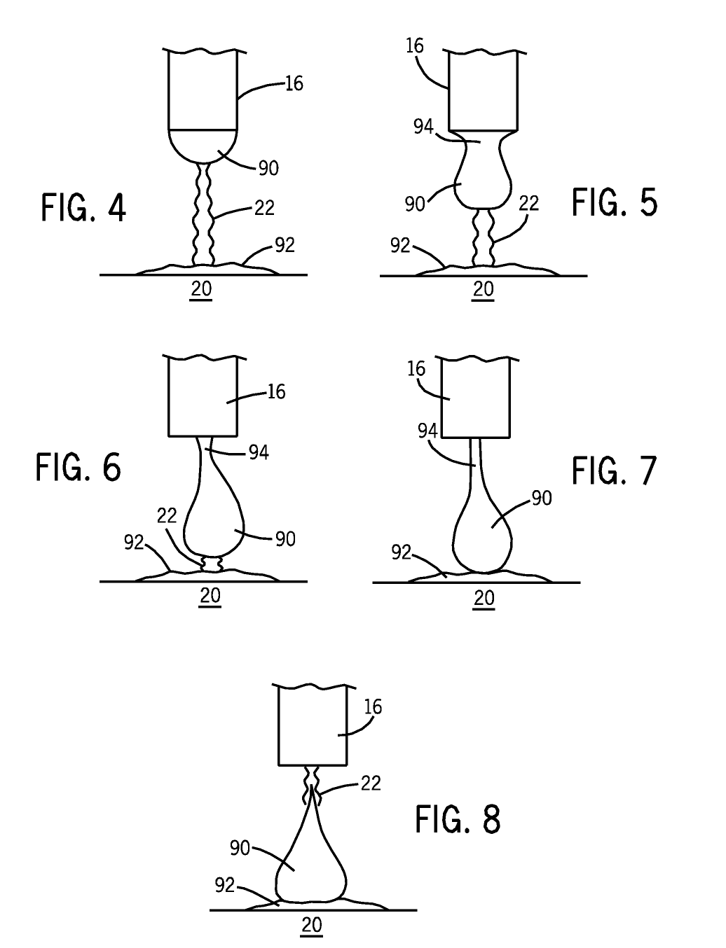

FIGS. 4-8 illustrate exemplary magnified views of the welding electrode 16 through the various phases discussed above in accordance with an embodiment of the present invention. FIG. 4 portrays a molten droplet 90 forming at the tip of electrode 16 during a first background phase. Arc 22 initially stretches between the tip of electrode 16 and the work piece 20, heating each. The heat from arc 22 melts the tip of electrode 16 to form molten droplet 90, while maintaining weld puddle 92 fluid on the work piece 20. When the molten droplet 90 forms on the tip of electrode 16, arc 22 spans from molten droplet 90 to the weld puddle 92.

FIG. 5 represents the welding electrode 16 during a peak phase, when the molten droplet 90 substantially begins to transfer toward weld puddle 92. To facilitate the movement of the molten droplet 90, higher voltage and current through arc 22 cause the arc to emit considerably more heat. As the molten droplet 90 begins to move away from the tip of electrode 16, a molten tail 94 begins to form between the tip of electrode 16 and the molten droplet 90.

In FIG. 6, which depicts a second background phase, the power of arc 22 has reduced as the voltage and current have returned from peak levels. Accordingly, the molten droplet 90 approaches the weld puddle 92 while the molten tail 94 elongates.

FIG. 7 illustrates a restrike delay phase, when the molten droplet 90 reaches the weld puddle 92 before the molten tail 94 has fully detached from the tip of electrode 16, extinguishing the arc and causing a short circuit. During the restrike delay phase, the current between electrode 16 and work piece 20 is maintained at a level high enough to keep the molten droplet 90 and molten tail 94 substantially fluid while transferring to the weld puddle 92, but low enough not to cause excessive spatter or outgassing after the short circuit clears and the arc restrikes.

FIG. 8 represents welding electrode 16 immediately after the molten tail 94 detaches from the tip of electrode 16, causing the short circuit to clear and arc 22 to restrike. In some embodiments, the current may be reduced immediately when arc 22 restrikes to prevent spattering molten droplet 90 while transferring into weld puddle 92.

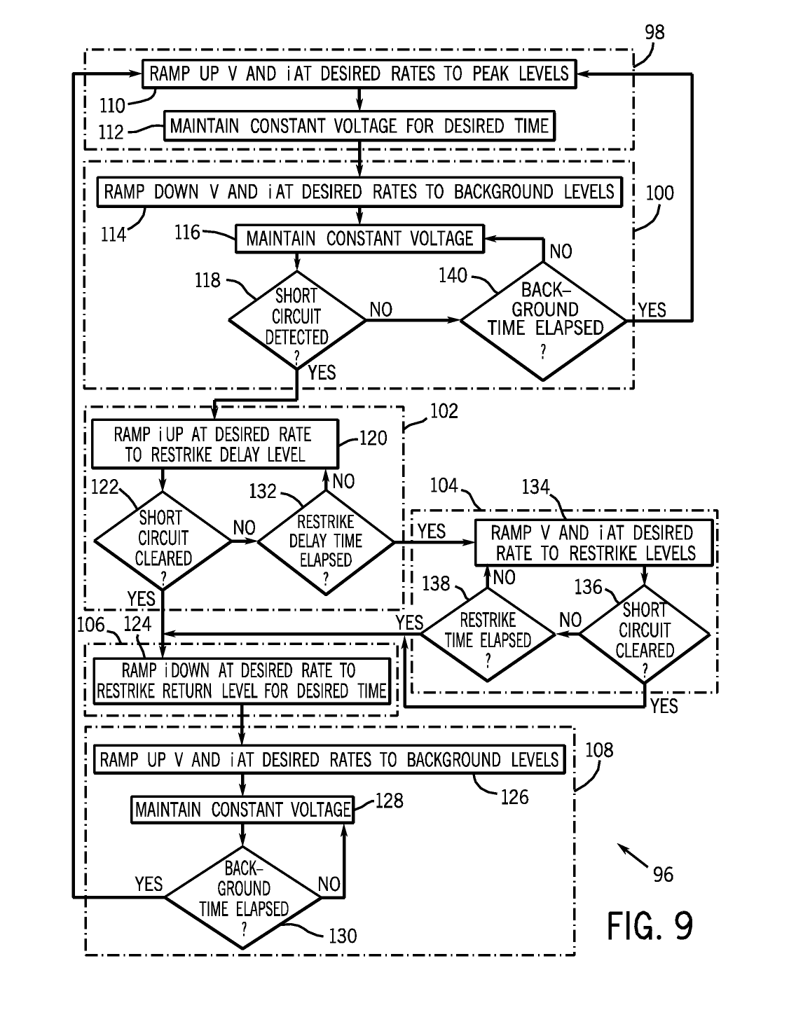

Turning to FIG. 9, flowchart 96 illustrates an exemplary method of controlling the voltage and current to welding electrode 16 in accordance with an embodiment of the present technique. When the flowchart begins at block group 98, a molten droplet 90 may have already formed on the tip of the electrode 16 during a background phase 108. Block group 98 represents a peak phase, during which the molten droplet 90 may begin to move toward the weld puddle 92, assisted by step 110, ramping voltage and current to peak levels, and step 112, maintaining a constant peak voltage level 64 for a desired peak phase time 54.

The proximate block group represents a background phase 100, wherein the molten droplet 90 may continue toward the weld puddle 92, assisted by step 114, ramping voltage and current down to background levels, and step 116, maintaining a constant background voltage level 58. As illustrated by decision block 118, background phase 100 may end when a short circuit is detected and the process flow enters block group 102. The system may detect a short circuit when voltage naturally drops below a threshold voltage level 78, indicating that the molten droplet 90 has reached the weld puddle 92 without detaching from the tip of electrode 16 and may have extinguished the arc 22. Decision block 140 illustrates that if a short circuit is not detected before a desired background time has elapsed, the process flow returns to the peak phase block group 98.

Block group 102 represents a restrike delay phase. Step 120, ramping and holding the current to a constant restrike delay current level, is calculated to keep the molten droplet 90 fluid so the molten tail 94 may disconnect from the tip of the electrode 16 on its own. Decision blocks 122 and 132 test first whether the short circuit has cleared on its own, and second whether a restrike delay phase time 56 has elapsed. As long as neither is true, step 120 maintains the current at a constant level. If the system detects the voltage to cross above a threshold voltage level before time elapses, indicating the short circuit has cleared, the process flow may progress to a restrike return phase as represented by block group 106. If time elapses before the short circuit is detected to have cleared, the process flow may transfer to a restrike phase, illustrated by block group 104. When the system variables are properly calibrated, short circuits should most often clear before the restrike delay time 56 elapses. Accordingly, the process flow will first be discussed as if the short circuit has cleared on its own during the restrike delay phase, before discussing the alternative.

Continuing to refer to FIG. 9, if the short circuit clears before the desired restrike delay time elapses, the process flow may enter a restrike return phase as represented by block group 106. Comprising a single step 124, ramping current down to a restrike return current level for a desired time, the restrike return phase aims to reduce the power of arc 22 upon restrike, so as to minimize spatter and other negative effects of the restrike on weld puddle 92.

After the desired restrike return phase time has passed, the process flow enters background phase 108. To grow a molten droplet 90 at the tip of electrode 16, background phase 108 comprises step 126, ramping up voltage and current to background levels, and step 128, maintaining voltage constant at a background voltage level. Decision block 130 ensures the arc 22 is maintained at a constant voltage until a desired background time has elapsed and the process returns to a peak phase, represented by block group 98. To conform to a constant period, decision block 130 may measure the desired background time from the start of background phase 100. In this way, when a short circuit clears during the restrike delay phase of block group 102, the peak phase of block group 98 will consistently repeat at a period comprising the peak phase time added to the background time, without regard to time spent in a restrike delay phase.

Referring again to block group 102, if alternatively the restrike delay phase time 56 elapses before the short circuit clears, the process flow may transfer to a restrike phase represented by block group 104. The restrike phase employs step 134, ramping current up to restrike current levels, until either the short circuit clears (see decision block 136) or the restrike phase time elapses (see decision block 138). To balance clearing the short circuit relatively quickly with minimizing the current level at the moment the short circuit clears, the restrike current ramp rate 88 may be calculated such that the current reaches the restrike current level within approximately half of the ordinary waveform period. For example, for a period of 4.5 ms, a restrike current ramp rate may be 300 A/ms. The process may progress to a restrike return phase, as represented by block group 106, when the short circuit is cleared or the restrike phase time elapses. From block group 106, the process flow proceeds.

As noted above, the ability to provide a very short peak voltage pulse, as well as the ability to control the pulse duration allows the waveforms and control techniques described above to be used with metal core welding wires. In particular, one or more settings may be provided for such metal core applications, with presently contemplated settings designed to accommodate 0.045 and 0.052 inch AWS E70C-6M wires. Other wire diameters, such as 0.062 inch wire.

Similarly, due to the reduced energy input offered by the waveforms and control techniques, thin metals may be welded with reduced risks of burn-through. For example, the waveforms are believed to be particularly advantageous for welding steels, such as cold rolled steels, with thicknesses of 16 gauge to 0.375 inch, and more particularly in a range of from 14 gauge to 0.312 inch.

Again, for metal core wires, a range of settings may be envisaged for the voltage peak pulse width to reduce ill effects on the wire core, and to reduced spatter. For example, for 0.045 inch wire, a pulse width on the order of 1.0 ms is contemplated for a wire feed speed of 200-500 inches per minute (IPM). For higher wire feed speeds, longer periods may be used, such as 1.2 ms at 600 IPM. Other durations might be used for other sizes of wire, such as 1.2-1.4 ms for 0.052 inch wire. In general, however, the ability to control the peak pulse width to below about 2.0 ms (and particularly to below about 1.8 ms) is believed to offer significant promise in terms of reducing weld spatter, burn-through and damage to metal core wires.

Regarding the particular frequencies that may be used for the waveform (i.e., the rate of repetition of the overall waveform discussed above), a range of frequencies may be envisaged, which may depend upon the wire size and the feed speed. For example, it has been found that for 0.045 inch wire, a frequency of 190-340 Hz works well for feed speeds of between 200 and 600 IPM.

Within these ranges, particular settings might include, for example, 190 Hz at 200 IPM, 220 Hz at 300 IPM, 250 Hz at 400 IPM, 280 Hz at 500 IPM, and 340 Hz at 600 IPM. Thus, depending upon the frequency of repetition of the waveform and the peak pulse width selected, it can be seen that the pulses are very short as compared to the length of the overall waveform. In particular, based upon the ranges discussed above, the ratio of the peak pulse duration to the waveform duration may be on the order of 40-67% for pulses of a duration of approximately 2 ms, and less for shorter duration peak pulses, such as on the order of 20-33%.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for controlling a welding system comprising:
(a) applying a voltage and a current to a welding electrode;
(b) applying an increased voltage and an increased current to the welding electrode;
(c) increasing the current applied to the welding electrode when a short circuit is detected; and
(d) maintaining the increased current applied to the welding electrode until a desired time expires after the short circuit is detected or until the short circuit clears, whichever occurs first.

2. The method of claim 1, further comprising detecting when the short circuit has cleared and allowing the voltage and the current to increase to cyclically repeat steps (a) through (d).

3. The method of claim 2, comprising reducing the current applied to the welding electrode following detection that the short circuit has cleared.

4. The method of claim 1, wherein the desired time is preset by a control algorithm.

5. The method of claim 1, wherein the short circuit is caused by molten metal from the electrode contacting both the electrode and a weld pool, and wherein the increased current is maintained for a time sufficient to allow the molten metal to detach from the electrode.

6. The method of claim 1, wherein the desired time comprises approximately one-tenth to one-third of the total time to complete steps (a) through (d).

7. The method of claim 1, wherein the desired time is approximately 0.5 ms to 1.5 ms.

8. The method of claim 1, wherein the increased voltage is approximately double the voltage applied to the welding electrode.

9. The method of claim 1, wherein the voltage applied to the welding electrode is approximately 17 volts and the increased voltage is approximately 35 volts.

10. A method for controlling a welding system comprising:
(a) applying an initial voltage and an initial current to a welding electrode to maintain an arc and thereby to create molten metal at a tip of the electrode;
(b) applying an increased voltage and an increased current to the welding electrode to drive the molten metal toward a weld pool;
(c) increasing the current applied to the electrode when a short circuit is detected by contact of the molten metal with both the electrode and the weld pool;
(d) maintaining the increased current applied to the electrode for a desired time after the short circuit is detected to allow deposition of the molten metal into the weld pool; and
(e) detecting when the short circuit has cleared and the arc between the electrode and the weld pool has been re-established.

11. The method of claim 10, wherein steps (a) through (e) are repeated at a predetermined frequency.

12. The method of claim 10, wherein the initial voltage is configured to be low enough to cause short circuits to occur regularly but high enough to create molten metal at the tip of the electrode.

13. The method of claim 10, further comprising reducing the voltage and the current and repeating step (a) once a predetermined time has elapsed after starting step (b).

14. The method of claim 13, wherein the predetermined time is such that the molten metal is only partially driven toward the weld pool during step (b).

15. The method of claim 10, wherein detecting when the short circuit has cleared comprises detecting when the voltage rises above an arc threshold voltage.

16. A welding system comprising:
a power supply;
a welding torch coupled to the power supply, the welding torch supporting a welding electrode that receives power from the power supply during welding operations; and
control circuitry configured to apply an initial voltage and an initial current to the welding electrode, to apply an increased voltage and an increased voltage to the welding electrode, to increase a current applied to the electrode when a short circuit is detected, and to maintain the increased current applied to the electrode for a desired time after the short circuit is detected or until the short circuit clears, whichever occurs first.

17. The welding system of claim 16, wherein the initial voltage applied to the welding electrode and the increased voltage applied to the welding electrode are configured to cause short circuits to occur regularly.

18. The welding system of claim 16, wherein the control circuitry is configured to detect the short circuit when the voltage drops below a threshold voltage level.

19. The welding system of claim 16, wherein the control circuitry is configured to detect when the short circuit clears when the voltage rises above a threshold voltage level.

20. The welding system of claim 16, wherein the control circuitry is configured to apply a reduced current to the electrode after the short circuit clears for a predetermined time.

21. A voltage and current waveform comprising:
(a) a background phase at a constant background voltage level and a variable current level;
(b) a peak phase at a constant peak voltage level and a variable current level; and
(c) a restrike delay phase at a short-circuit voltage level and a constant restrike delay current level.

22. The voltage and current waveform of claim 21, further comprising (d) a restrike return phase at a variable voltage level and a constant restrike return current level.

23. The voltage and current waveform of claim 21, wherein the restrike delay phase ends after a desired time has elapsed or a threshold voltage is crossed, whichever comes first.

24. The voltage and current waveform of claim 21, wherein the peak phase lasts approximately one-fifth the total time.

25. The voltage and current waveform of claim 21, wherein the restrike delay phase lasts approximately one-tenth to one-third of the total time.

26. A method for controlling a welding system comprising:
applying a pulsed waveform to a welding wire, the waveform having first duration and a peak voltage, current, power or energy pulse of a second duration, wherein a ratio of the second duration to the first duration is less than approximately 67%.

27. The method of claim 26, wherein the ratio of the second duration to the first duration is less than approximately 40%.

28. The method of claim 27, wherein the ratio of the second duration to the first duration of the waveform is approximately 20%.

29. The method of claim 26, wherein the second duration is less than approximately 1.8 ms.

30. The method of claim 29, wherein the second duration is less than approximately 1.2 ms.
